(19) United States
(12) Patent Application Publication
(10) Pub. No.: US 2026/0210333 A1
(43) Pub. Date: Jul. 23, 2026

(54) A METHOD FOR ASSEMBLING A TOWER PART OF A WIND TURBINE AND USE HEREOF

(71) Applicant: KK Wind Solutions A/S, Ikast (DK)

(72) Inventors: Jorgen Dahl Vestergaard, Kibaek (DK); Poul Thing, Ikast (DK)

(21) Appl. No.: 19/139,719

(22) PCT Filed: Dec. 12, 2023
(86) PCT No.: PCT/DK2023/050301

§ 371 Date: Jun. 16, 2025

(30) Foreign Application Priority Data
Dec. 16, 2022 (DK) PA202270621

(51) Int. Cl. F03D 13/10; E04H 12/34

(52) U.S. Cl. CPC F03D 13/112; E04H 12/345; F03D 13/126; F05B 2230/60; F05B 2240/912; F05B 2240/95

(57) ABSTRACT

A method for assembling a tower part of a wind turbine. The method includes placing an elongated tubular tower section of the wind turbine so that it is laying down and so that at least a part of an outer elongated surface of the tower section is supported by an underlying surface and forming an electrical module. The electrical module includes at least one electronic subsystem of the wind turbine. The method further includes transporting the electrical module into the elongated tubular tower section and tilting the electrical module substantially 90 degrees, and connecting the electrical module to at least two opposing inside surfaces of the elongated tubular tower section.

### BACKGROUND OF THE INVENTION

The invention relates to a method for assembling a tower part of a wind turbine by connecting an electrical module to an inside surface of a tower section and use hereof.

### DESCRIPTION OF THE RELATED ART

In relation to large modern wind turbines it is known to arrange electrical components such as transformers, converters, switch gear and other inside the tower of the wind turbine.

E.g., from the European patent application EP 1 788 242 A1 it is known to arrange electrical components on a platform and then lowering the platform down into the tower by means of a large crane at the wind turbine erection site.

Likewise, from the German patent application DE 10 2009 055 726 A1 it is known to install an internal lattice tower inside a tubular wind turbine tower section before the tower section is transported to the erection site. At the erection site the tower section is erected and platforms comprising electrical components are lowered down into the vertical tower section and connected to the internal lattice tower. However, lowering platforms down into the tower by means of a large crane is a complex and costly process and installation at the erection site is complex e.g., due to rain, wind and other—particularly offshore.

An object of the invention is therefore to provide for an advantageous technique for assembling a tower part of a wind turbine.

### THE INVENTION

The invention provides for a method for assembling a tower part of a wind turbine. The method comprises placing an elongated tubular tower section of the wind turbine so that it is laying down and so that at least a part of an outer elongated surface of the tower section is supported by an underlying surface and forming an electrical module comprising at least one electronic subsystem of the wind turbine. The method further comprises transporting the electrical module into the elongated tubular tower section and tilting the electrical module substantially 90 degrees. Even further the method comprises connecting the electrical module to at least two opposing inside surfaces of the elongated tubular tower section.

Placing the tower section so that it is laying down before transporting the electrical module into the elongated tubular tower section and connecting the electrical module to inside surfaces of the elongated tubular tower section is advantageous in that the use of large cranes hereby can be avoided, and the entire assembly process can be performed at ground level making the assembly process both safer and less expensive.

Furthermore, tilting the electrical module substantially 90 degrees before, during or after transporting it into the tower section is advantageous in that the electrical module in this way will regain its original orientation along with the tower section when the tower section is raised to its intended vertical orientation when it forms part of the wind turbine tower. In this way the electrical module can be produced, stored, transported etc.—prior to being mounted in the tower section—in the same normal intended orientation as it will have in the erected wind turbine tower, which is advantageous in that it hereby is easier to manufacture, form, handle, transport etc.

It should be noted that the present method is not limited to transporting the electrical module into the tower section before tilting the electrical module substantially 90 degrees. The present method also includes tilting the electrical module substantially 90 degrees before transporting the electrical module into the tower section and tilting the electrical module substantially 90 degrees while transporting the electrical module into the tower section.

Furthermore, it should be noted that connecting the electrical module to at least two opposing inside surfaces of the tower section is not limited to connecting the electrical module directly to the opposite inside surfaces in the tower. I.e. this passage also includes connecting the electrical module indirectly to the opposite inside surfaces in the tower e.g. by means of fittings, support brackets, flanges or other connected to the inside surfaces of the tower. And “opposing inside surfaces” is not limited to surfaces being parallel—like two opposing inside surfaces of a square tower section. I.e. the term also covers two opposing inside surfaces of a triangular tower section, two opposing inside surfaces of a cylindrical tower section, two opposing inside surfaces of a polygonal tower section or similar where the at least two opposing inside surfaces is not facing directly against each other.

Even further, it should be noted that the term “electrical module” includes any kind of module comprising at least one electronic subsystem of the wind turbine. I.e. the term includes any kind of transformers, converters, switch gear, electrical panels and other either combined, on their own and/or e.g. mounted on a base structure, a frame, a base plate, in a container or other to form a module.

Also note that any reference to orientation—i.e., up, down, side, top bottom etc.—throughout this document is—unless otherwise mentioned—made in relation to the tower section laying down as it would be during the assembly process and the electrical module standing as it is intended to be in the fully functional wind turbine or tilted substantially 90 degrees as it is at least during some parts of the assembly process—particularly when it is connected to the inside surfaces of the laying down tower section.

In an aspect of the invention, the method further comprises erecting the tower section and connecting the tower section to a wind turbine foundation after the electrical module has been connected to the at least two opposing inside surface of the tubular tower section.

Erecting the tower section after the electrical module has been connected to the inside surfaces of the tower section is advantageous in that everything hereby is erected at once and that the tower including the electrical module hereby can be connected to the wind turbine foundation in a single operation. Furthermore, subsequent installation of modules in the tower section by means of cranes at the erection site is hereby avoided.

It should be noted that the term “connecting the tower section to a wind turbine foundation” also includes connecting the tower section indirectly to the wind turbine foundation e.g. through another tower section, through a transition piece, through a platform arrangement or other.

In an aspect of the invention, the electrical module forms part of a tower platform inside the tower section once the electrical module is connected to the at least two opposing inside surface of the elongated tubular tower section.

Making the electrical module form part of a tower platform inside the tower section is advantageous in that the electrical module hereby is more easily accessible for service, maintenance, and repair.

In an aspect of the invention, the method further comprises forming a tower platform inside the elongated tubular tower section before connecting the electrical module to the at least two opposing inside surface of the elongated tubular tower section, wherein the tower platform comprises a gap adapted to fit the electrical module and wherein the electrical module is connected to the at least two opposing inside surface of the elongated tubular tower section in the gap.

Forming a tower platform inside the tower section before connecting the electrical module to the tubular tower section is advantageous in that the tower platform hereby is easier to handle and fit.

In an aspect of the invention, the method further comprises connecting tower platform plates on opposite sides of the electrical module before transporting the electrical module into the elongated tubular tower section.

Connecting tower platform plates on opposite sides of the electrical module—e.g., by means of hinges allowing the tower platform plates to be folded up alongside the module during tiling and transport—before transporting the electrical module into the tower section is advantageous in that the tower platform plates hereby can be fitted in the tower section in the same procedure as the electrical module, hereby simplifying the assembly process.

In an aspect of the invention, the method further comprises adjusting the length of the electrical module by means of length adjustment means of the electrical module in accordance with a distance between the at least two opposing inside surfaces of the elongated tubular tower section before connecting the electrical module to the at least two opposing inside surfaces of the elongated tubular tower section.

A typical wind turbine tower is coning slightly towards the top and the distance between opposing inside surfaces will therefore vary throughout the length (i.e. height when erected) of the tower section and it is therefore advantageous to provide the electrical module with length adjustment means. Furthermore, due to gravitational pull the tower section can become oval when laying down and it is therefore advantageous to provide the electrical module with length adjustment means to compensate for this ovality.

In this embodiment “length” refers to the length of the electrical module in the transverse direction of the tower section once the electrical module is connected to the two opposing inside surfaces of the tower section.

Furthermore, in this context the term “length adjustment means” refers to any kind of length adjuster suited for adjusting the length of an electrical module. I.e. the term includes any kind of telescopic arrangement, adjustable slider, expansion element or other being manually adjustable and/or being automatically adjustable by means of actuators, pistons, spring or other or any combination thereof.

In an aspect of the invention, the method further comprises providing the electrical module with module self-locking means and providing the inside surface of the tower section with tower self-locking means before connecting the electrical module to the at least two opposing inside surface of the elongated tubular tower section, and the method further comprises connecting the electrical module to the at least two opposing inside surfaces of the elongated tubular tower section by engaging the module self-locking means and the tower self-locking means to self-lock the electrical module and the tower section against mutual displacement once the module self-locking means and the tower self-locking means are engaged.

Providing the electrical module with module self-locking means and the inside surface of the tower section with tower self-locking means arranged to lock together when engaged is advantageous in that the electrical module hereby will be locked against movement in relation to the tower section as soon as the module self-locking means and the tower self-locking means are engaged and connecting the electrical module to the tower section hereby can take place without personnel placed in the tower section—maybe except for the person driving a transport vehicle transporting the electrical module into the tower section. Hereby is safety and assembly time improved.

In this context the term “self-locking means” refers to any kind of self-lock suited for locking itself to another self-lock as soon as the two are brought into engagement. I.e. the term includes any kind of latch arrangement, snap lock arrangement, spring lock arrangement, matching interlocking geometry or other.

In an aspect of the invention, the method further comprises manually connecting the electrical module to the at least two opposing inside surfaces of the elongated tubular tower section by means of connection means after the module self-locking means and the tower self-locking means are engaged.

Connecting the electrical module to the tower section by means of manually fitted connection means after the initial self-locking process has been performed is advantageous in that the connected hereby can be made more durable and stable, and the additional connection means will increase safety. Furthermore, the connection means may lock the electrical module to the tower section in more directions that the original self-locking means hereby enabling that the assembled tower part may be handled more freely.

In this context the term “connection means” refers to any kind of connector suited for additionally connecting the electrical module to the tower section. I.e. the term includes any kind of screws, bolts, rivets, plug, peg, welding or other.

In an aspect of the invention, the electrical module is transported into the elongated tubular tower section and tilted substantially 90 degrees by the same transport vehicle.

Transporting the electrical module into the tower section and tilting it by means of the same transport vehicle is advantageous in that this will simplify and speed up the assembly process.

In an aspect of the invention, the electrical module is tilted substantially 90 degrees before the electrical module is transported into the elongated tubular tower section.

Tilting the electrical module before it is transported into the tower section is advantageous in that this will provide more space for performing the tilting operation—e.g. by means of a dedicated tilting arrangement. Furthermore, this will enable a simpler transport vehicle.

In an aspect of the invention, the method further comprises

connecting the electrical module to a transport vehicle by means of vehicle locking means before transporting the electrical module into the elongated tubular tower section by means of the transport vehicle, and

remotely disconnecting the electrical module from the transport vehicle by remotely disengaging the vehicle locking means after connecting the electrical module to the at least two opposing inside surfaces of the elongated tubular tower section.

Connecting the electrical module to a transport vehicle by means of vehicle locking means and then remotely disconnecting the electrical module from the transport vehicle after the electrical module has been connected to the tower section is advantageous in that this enables that the electrical module can be released from the transport vehicle remotely—e.g. from a safe place by an operator of the transport vehicle—which will increase safety and assembly speed.

In this context the term “vehicle locking means” refers to any kind of vehicle lock suited for connecting an electrical module to a transport vehicle. I.e. the term includes any kind of twist-lock arrangement, latch arrangement, snap lock arrangement, spring lock arrangement, bolt connection or other.

In an aspect of the invention, the method further comprises moving the transport vehicle out of the elongated tubular tower section after remotely disconnecting the electrical module from the transport vehicle.

Moving the transport vehicle out of the tower section after remotely disconnecting the electrical module from the transport vehicle is advantageous in that the transport vehicle hereby will not take up space in the tower section and the transport vehicle can be reused for connection a further electrical module in the tower section.

In an aspect of the invention, the method further comprises forming at least one further electrical module comprising at least one further electronic subsystem of the wind turbine,

transporting the at least one further electrical module into the elongated tubular tower section,

tilting the at least one further electrical module substantially 90 degrees, and

connecting the at least one further electrical module to an inside surface of the elongated tubular tower section at a position displaced in relation to the initial electrical module in the elongated direction of the elongated tubular tower section.

Placing a further electrical module—i.e. a second electrical module—in the tower section displaced from the initial electrical module—i.e. the first electrical module—is advantageous in that the space inside the tower section hereby is better utilized.

In an aspect of the invention, the electrical module is transported into the elongated tubular tower section through a first end opening of the elongated tubular tower section and wherein the at least one further electrical module is transported into the elongated tubular tower section through a second end opening of the elongated tubular tower section, wherein the first end opening, and the second end opening are arranged at opposite ends of the elongated tubular tower section.

Transporting a first electrical module into the tower section through a first end opening and transporting a second electrical module into the tower section through a second end opening is advantageous in that both modules hereby can be connected to the inside of the tower section simultaneously and/or it enables shorter transportation distance and time inside the tower section.

In an aspect of the invention, the method further includes forming the electrical module by placing the at least one electronic subsystem on a base structure of the electrical module and connecting the at least one electronic subsystem to the base structure.

Placing the electronic subsystem on a base structure and connecting it to the base structure is advantageous in that it hereby is possible to mount the non-uniform electronic subsystem components on a more uniform base structure e.g. better suited to be connected to and handled by a transport vehicle and e.g. better suited for being connected to the inside of the tower section.

In an aspect of the invention, the method further includes tilting the electrical module substantially 90 degrees by tilting the base structure from a substantially horizontal orientation to a substantially vertical orientation.

Initially having the electrical module substantially horizontal is advantageous in that this will simplify the process of connecting the components of the electronic subsystem and it will simplify handling, storing, transport and other until the electrical module is fitted inside the tower section. And tilting the electrical module substantially 90 degrees is advantageous in that it hereby can be mounted more easily in a laying down tower section.

The invention further provides for use of a method according to any of the previously discussed methods for assembling a tower part of an offshore wind turbine.

Offshore crane time is very expensive, and it requires very calm weather to crane an electrical module vertically down into a tower section offshore. Thus, it is particularly advantageous to use the method according to the present invention in for assembling a tower part of an offshore wind turbine.

### FIGURES

The invention will be described in the following with reference to the figures in which

FIG. 1. illustrates a large modern wind turbine,

FIG. 2 illustrates an electrical module being delivered at an assembly site, as seen in an isometric view,

FIG. 3 illustrates a forklift comprising a transport vehicle ready to engage an electrical module, as seen in an isometric view,

FIG. 4 illustrates a forklift placing a transport vehicle and an electrical module in a tower section, as seen in an isometric view,

FIG. 5 illustrates a transport vehicle and an electrical module inside a tower section, as seen in an isometric view,

FIG. 6 illustrates an electrical module being connected to a tower section, as seen in an isometric view,

FIG. 7 illustrates electrical modules being placed in a tower section by forklifts comprising a scissor arrangement, as seen in an isometric view,

FIG. 8 illustrates a forklift traveling on a plate arrangement in a tower section, as seen in an isometric view,

FIG. 9 illustrates a transport vehicle placing an electrical module in a tower section, as seen in an isometric view,

FIG. 10 illustrates a transport vehicle comprising a reciprocating wheeled beam, as seen in an isometric view,

FIG. 11 illustrates a transport vehicle comprising a reciprocating self-supported beam, as seen in an isometric view,

FIG. 12 illustrates a transport vehicle placing a tower platform plate in a tower section, as seen in an isometric view,

FIG. 13 illustrates a transport vehicle tilting an electrical module, as seen in an isometric view,

FIG. 14 illustrates a transport vehicle placing an electrical module in a tower section, as seen from the side,

FIG. 15 illustrates an electrical module comprising manual length adjustment means and twist lock, as seen in an isometric view,

FIG. 16 illustrates a first embodiment of module self-locking means and tower self-locking means, as seen in an isometric view,

FIG. 17 illustrates a second embodiment of module self-locking means and tower self-locking means, as seen from the side,

FIG. 18 illustrates a third embodiment of module self-locking means and tower self-locking means, as seen from the side, and

FIG. 19 illustrates an electrical module comprising automated length adjustment means, as seen from one end of the tower section.

### DETAILED DESCRIPTION

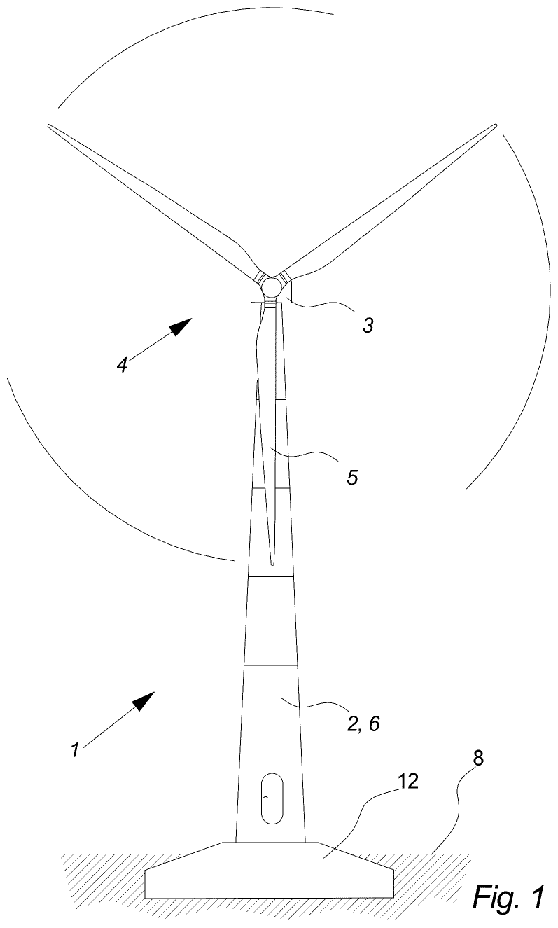

FIG. 1 illustrates a modern wind turbine 1 comprising a tower 2 with a door and a wind turbine nacelle 3 positioned on top of the tower 2. The wind turbine rotor 4, comprising three wind turbine blades 5, is connected to the nacelle 3 through the low speed shaft which extends out of the nacelle 3 front.

In this embodiment the tower 2 is formed by six individual tower sections 6 being connected together. However, in another embodiment the tower 2 could comprise fewer tower sections—such five, three or even a single—or the tower 2 could comprise more tower sections 6—such as eight, twelve, twenty or even more.

In this embodiment the wind turbine 1 is an onshore wind turbine 1 placed on a ground foundation 12 fixed in an underlying surface 8 in the form of the ground but in another embodiment the wind turbine 1 could be an offshore wind turbine 1 and the foundation 12 could instead be a monopile foundation, a jacket foundation, a floating foundation or other e.g., comprising a transition piece or other.

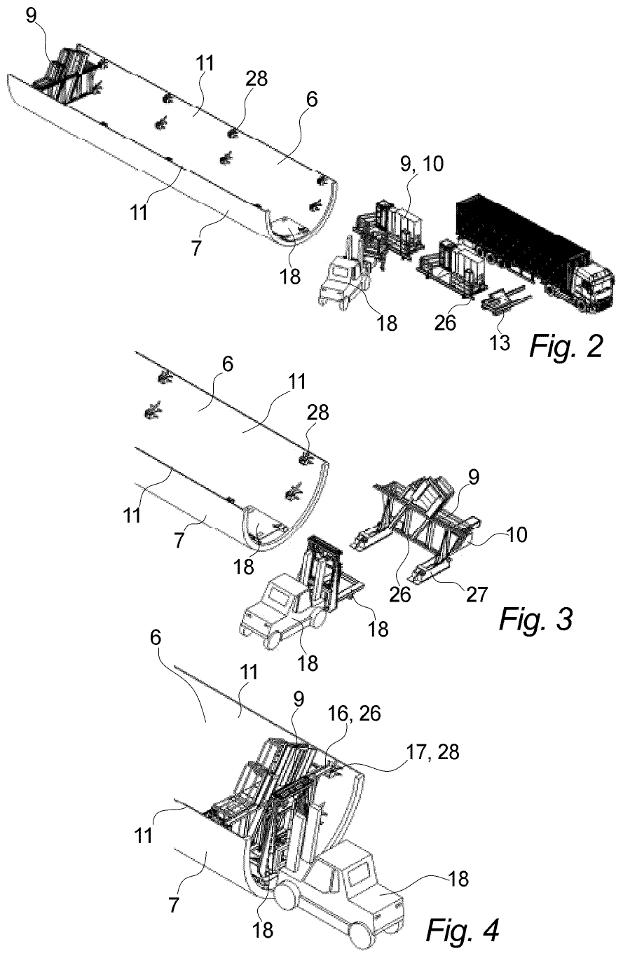

FIG. 2 illustrates an electrical module 9 being delivered at an assembly site, as seen in an isometric view.

In this embodiment the assembly site is a waterfront at an industrial harbor where the tower part is preassembled by connecting one or more electrical modules 9 to the inside of a tower section 6 of a wind turbine tower 2 but in another embodiment the assembly site could be the manufacturing plant where the tower section 6 is produced, the manufacturing plant where the electrical modules 9 are produced or elsewhere. However, the assembly of the tower part preferably takes place on land to simplify transport of the electrical modules 9 to and into the tower section 6.

In this embodiment the electrical module 9 comprises a base structure 26 formed by a base frame, flooring, railing and other however in another embodiment the electrical module 9 could comprise less element and/or the electrical module 9 could comprise a container enclosing the electronic subsystem 10, a base structure 26 could be formed integrally with the electronic subsystem 10 or the electrical module 9 could be formed in numerous other ways.

In this embodiment the electrical module 9 comprises an electronic subsystem 10 of the wind turbine 1 which the tower part will form part of when the tower part has been erected and connected directly or indirectly to a wind turbine foundation to form part of said wind turbine 1.

In this embodiment the electronic subsystem 10 comprises a control cabinet and a switchbox but in another embodiment the electronic subsystem 10 could also or instead comprise converters, transformers, breakers, terminals, batteries and other.

In this embodiment the electrical module 9 has been formed by connecting the electronic subsystem 10 rigidly to the base structure 26 so that the electrical module 9 may be handles, tilted and other by engaging the base structure 26. However, in another embodiment the electrical module 9 may be handles, tilted and other by engaging the electronic subsystem 10 directly, by engaging another part of the electrical module 9 or in another way depending on the specific design of the electrical module 9 and other.

In this embodiment the electrical module 9 arrives at the assembly site by means of a truck from which the electrical module 9 is lifted and placed on a tilting device 27 (see FIG. 3) by means of a transport vehicle 18 in this case in the form of a more or less standard forklift. In this embodiment a separate tower platform 13—in the form of a gangway—is first connected to the electrical module 9 before the electrical module 9 is placed on the tilting device 27 (see FIG. 3). However, in another embodiment no tower platform 13 would be connected to the electrical module 9, more tower platforms 13 could be connected to the electrical module 9 and/or one or more tower platforms 13 could be connected to the electrical module 9 while the electrical module 9 is connected to the transport vehicle 18 or after installing in the tower section 6.

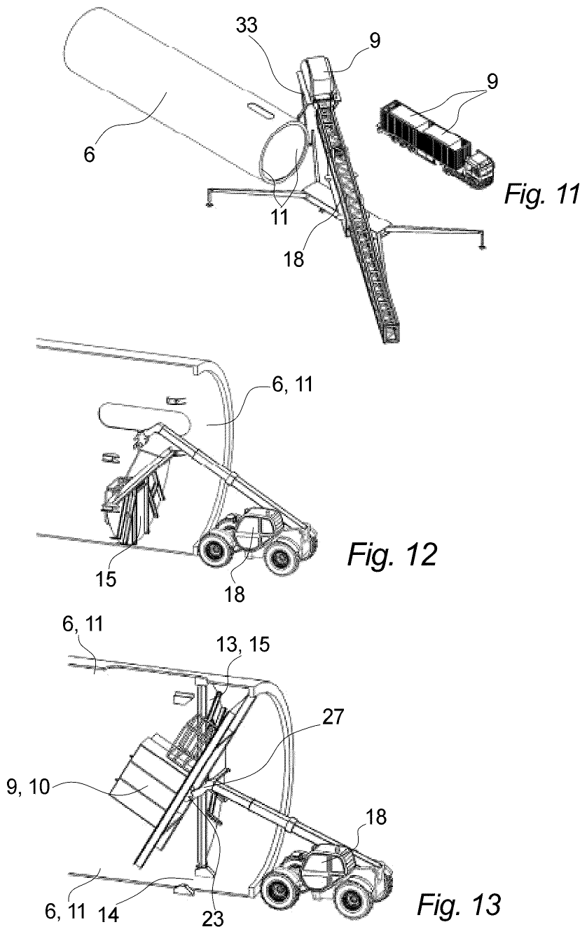

In FIG. 2 and in most of the figures, the tower section 6 is shown as a partial cutout to enable free view of the inside of the tower section 6. However, the tower section will obviously be formed as a closed tube (with open ends 24, 25) during assembly of the tower part—as shown in FIGS. 11 and 19.

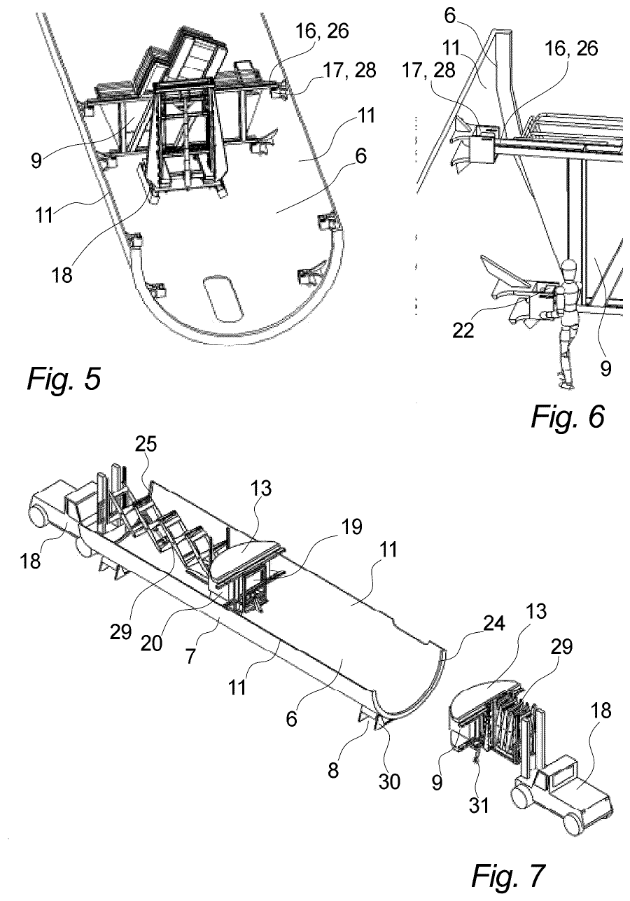

FIG. 3 illustrates a transport vehicle 18 in the form of a forklift comprising a further transport vehicle 18 ready to engage an electrical module 9 (see also FIGS. 4 and 5), as seen in an isometric view.

In this embodiment the tilting device 27 has tilted the electrical module 9 substantially 90 degrees so that the base structure 26 has been tilted from being substantially horizontal to being in a vertical position with the electronic subsystem 10 extending in a horizontal direction out in front of the base structure 26.

In this embodiment the transport vehicle 18 is formed by several different parts. An automotive carriage part of the transport vehicle 18 is placed in the tower section 6 and a displacement part of the transport vehicle 18 is grabbed by the forklift before engaging the electrical module 9. Thus, after the electrical module 9 has been tilted substantially 90 degrees the forklift comprising the displacement part of the transport vehicle 18 will engage the electrical module 9 and lift it of the tilting device 27 and transport it to the tower section 6.

FIG. 4 illustrates a forklift placing a transport vehicle 18 holding an electrical module 9 in a tower section 6, as seen in an isometric view and FIG. 5 illustrates a transport vehicle 18 transporting an electrical module 9 inside a tower section 6, as seen in an isometric view.

The forklift will place the displacement part comprising the electrical module 9 on the automotive carriage part of the transport vehicle 18 and the transport vehicle 18 inside the tower section 6 can now be remotely controlled to transport the electrical module 9 further into the tower section 6.

In the tower section 6 the displacement part of the transport vehicle 18 can adjust the vertical position of the electrical module 9 and displace the top of electrical module 9 back or forth in relation to the bottom of electrical module 9.

In this embodiment the two opposing inside surfaces 11 of the elongated tubular tower section 6 is provided with connection brackets 28 in the form of four cradle-like brackets welded to the two opposing inside surfaces 11 of the tower section 6. I.e. in this embodiment the electrical module 9 is connected to the two opposing inside surfaces 11 of the tower section 6 by the transport vehicle 18 placing the protruding ends of the base structure 26 above the connection brackets 28 and then lowering them down into the brackets 28. The transport vehicle 18 will now disengage the electrical module 9 and move towards the end of the tower section 6 where the forklift will pick up at least the displacement part of the transport vehicle and reuse it for the next electrical module 9 to be fitted.

I.e., in this embodiment the electrical module 9 is provided with module self-locking means 16 in the form of the protruding ends of the base structure 26 and the two opposing inside surfaces 11 of the tower section 6 is provided with tower self-locking means 17 in the form of the cradle-like connection brackets 28 before the electrical module 9 is connected to the tower section 6, and the electrical module 9 is thereafter connected to the two opposing inside surfaces 11 by engaging the module self-locking means 16 and the tower self-locking means 17 to make them self-lock. I.e. in this embodiment the connection process can take place without any personnel present inside the tower section which will increase safety.

FIG. 6 illustrates an electrical module 9 being connected to a tower section 6, as seen in an isometric view.

The cradle design of the connection brackets 28 ensures that the electrical module 9 is securely connected to the two opposing inside surfaces 11 of the tower section 6 as long as the tower section 6 maintains its position. However, to reinforce the connection, connection means 22—in this embodiment in the form of pegs—are manually placed and fixed in slots in the connection brackets 28 so that the electrical module 9 remains securely connected to the tower section 6 even if the tower section is rotated or erected.

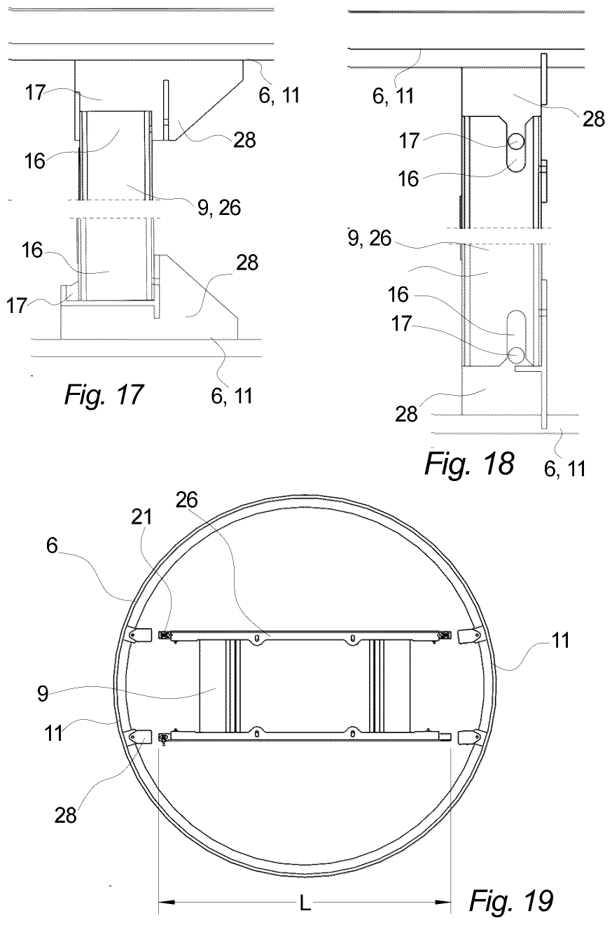

However, in another embodiment the electrical module 9 could be connected to the two opposing inside surfaces 11 of the tower section 6 by means of welding, by means of bolts, screws, rivets or the like or the electrical module 9 could be connected to the two opposing inside surfaces 11 by means of a multitude of other bracket designs e.g. as also disclosed in FIG. 17-19.

FIG. 7 illustrates electrical modules 9 being placed in a tower section 6 by forklifts comprising a scissor arrangement 29, as seen in an isometric view.

In this embodiment the transport vehicle 18 is a forklift comprising a scissor arrangement 29 and in this embodiment the transport vehicle 18 further comprises a carriage arrangement 31 comprising wheels enabling that the electrical module 9 may roll on the inner surface of the tower section 6 while being pushed along by the forklift comprising the scissor arrangement 29.

In this embodiment a first electrical module 9 is transported into the elongated tubular tower section 6 through a first end opening 24 of the elongated tubular tower section 6 and a further (a second) electrical module 19 is transported into the elongated tubular tower section 6 through a second end opening 25 located in the opposite end of the tower section 6. However, in another embodiment all electrical modules 9 could enter the tower section 6 through the same end opening 24, 25.

In this embodiment the elongated tubular tower section 6 is placed so that it is laying down and so that the outer elongated surface 7 of the tower section 6 is supported by an underlying surface 8—in the form of the ground. In this embodiment the tower section 6 is not placed directly on the underlying surface 8 but is instead supported indirectly by the underlying surface 8 by means of two roller supports 30 which in this case are driven so that the tower section 6 may be rotated by the roller supports 30 whiles being supported by the roller supports 30.

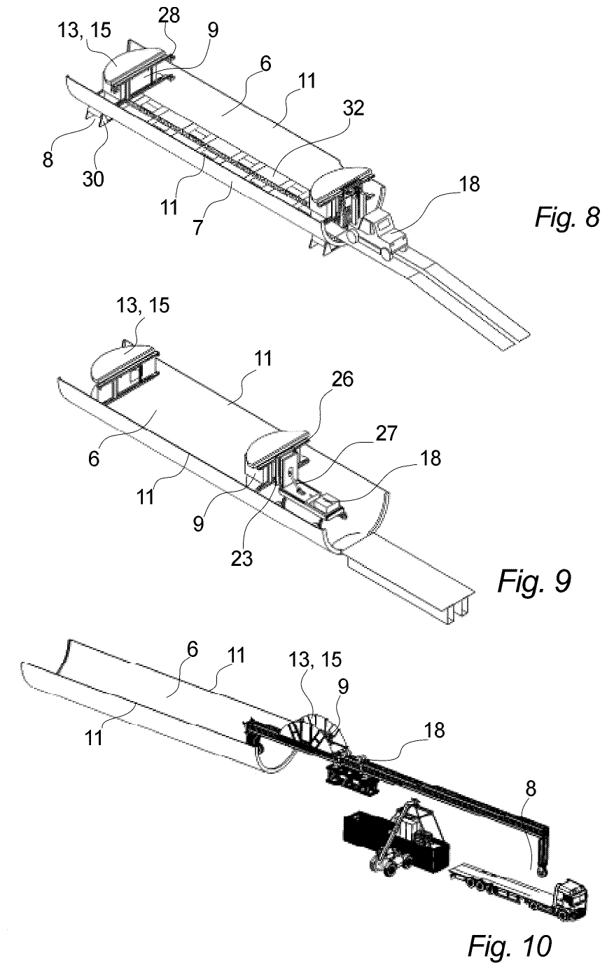

FIG. 8 illustrates a forklift traveling on a plate arrangement 32 in a tower section 6, as seen in an isometric view.

In this embodiment a plate arrangement 32 is first arranged inside and outside the laying down tower section 6 so that a transport vehicle 18 in the form of an ordinary forklift may travel in and out of the tower section to connect the electrical modules 9 to the inner surface of the tower section 6 while the driver of the forklift is protected by the enclosed cabin of the forklift.

In this embodiment tower platform plates 15 are connected to opposite sides of the electrical module 9 before the electrical module 9 is transported into the elongated tubular tower section 6. The tower platform plates 15 are connected to the electrical module 9 through hinges and locked in the raised position disclosed in e.g. FIGS. 8-10. Once the required number of electrical modules 9 have been connected to opposing inside surfaces 11 of the elongated tubular tower section 6, the roller supports 30 will rotated the tower section 6 90 degrees so that the hinges connecting the tower platform plates 15 to the electrical module 9 becomes substantially vertical and the platform plates 15 can now be released and swung out and locked in the new extended position, so that the tower platform plates 15 form a tower platform 13 around the electrical module 9. In this embodiment the tower platform plates 15 are only supported by the electrical module 9—which in turn is supported by the inside surfaces 11 of the tower section 6—but in another embodiment the tower platform plates 15 could also be connected to the inside surfaces 11 of the tower section 6 after being flipped out.

FIG. 9 illustrates a transport vehicle 18 placing an electrical module 9 in a tower section 6, as seen in an isometric view. In this embodiment the transport vehicle 18 is a dedicated automotive vehicle comprising a tilting device 27 enabling that the transport vehicle 18 may tilt the electrical module 9 substantially 90 degrees before the electrical module 9 is transported into the tower section 6, while the electrical module 9 is transported into the tower section 6 or after the electrical module 9 has been transported into the tower section 6.

In this embodiment the empty transport vehicle 18 is initially located on a ramp outside the tower section 6 with the tilting device 27 in a substantially horizontal position. A crane, a forklift or other will then place an electrical module 9 on the transport vehicle 18, wherein the electrical module 9 is placed on the transport vehicle 18 in its intended final orientation—i.e., the orientation it is supposed to have in the fully erected and fully functional wind turbine. In this embodiment the transport vehicle 18 is further provided with vehicle locking means 23 in the form of fully automatic Twist Locks as known from handling of standard ISO containers (see FIG. 15 for an embodiment of Twist Locks). The Twist Locks engages corresponding holes in the electrical module 9 (see e.g. the four holes in the bottom of the electrical module 9 in FIG. 19)—in this embodiment in the bottom of the base structure 26 of the electrical module 9—when the electrical module 9 is placed on the transport vehicle 18 and the vehicle locking means 23 will securely lock the electrical module 9 against any unwanted displacement in relation to the transport vehicle 18. The transport vehicle 18 can now tilt the electrical module 9 and transport the electrical module 9 into the elongated tubular tower section 6.

Once the transport vehicle 18 has connected the electrical module 9 to the two opposing inside surfaces 11 of the elongated tubular tower section 6, the vehicle locking means 23 are remotely disconnect and the electrical module 9 is thereby disconnected from the transport vehicle 18 and the transport vehicle 18 may travel out of the elongated tubular tower section 6 and e.g. prepare to receive another electrical module 9. However, in another embodiment the transport vehicle 18 could be more autonomous and the vehicle locking means 23 would be automatically disconnected when it is detected that the electrical module 9 is correctly connected to the opposing inside surfaces 11 of the tower section 6 or the vehicle locking means 23 could be fully or partly manually operated.

FIG. 10 illustrates a transport vehicle 18 comprising a reciprocating wheel-supported beam, as seen in an isometric view.

In this embodiment the transport vehicle 18 comprises a drive unit arranged to push and pull a reciprocating wheel-supported beam in and out of the tower section 6 wherein the beam in one end is supported by a wheel rolling on the inside bottom surface of the tower section 6 and in the opposite end by another wheel rolling on the underlying surface 8. In this embodiment the beam further comprises means for rotation, tilting and displacing the electrical module 9 so that the transport vehicle 18 may position and tilt the electrical module 9 correctly in relation to the intended brackets or other inside the tower section 6.

FIG. 11 illustrates a transport vehicle 18 comprising a reciprocating self-supported beam, as seen in an isometric view.

In this embodiment the electrical module 9 is initially lifted of a truck by means of a forklift, a crane or other and placed on a scissor lift or a similar height adjustable platform 33. The transport vehicle 18 in form of the beam arrangement will connect to the near end of the electrical module 9 and as the height adjustable platform 33 is lowered the far end or the electrical module 9 will move down until the electrical module 9 is hanging vertically and thereby have being tilted around 90 degrees. The beam is then retracted, turned to face the tower section 6, and extended into the tower section 6 to connect the electrical module 9 to the inside surfaces 11 of the tower section 6 while another electrical module 9 is lined up on the height adjustable platform 33.

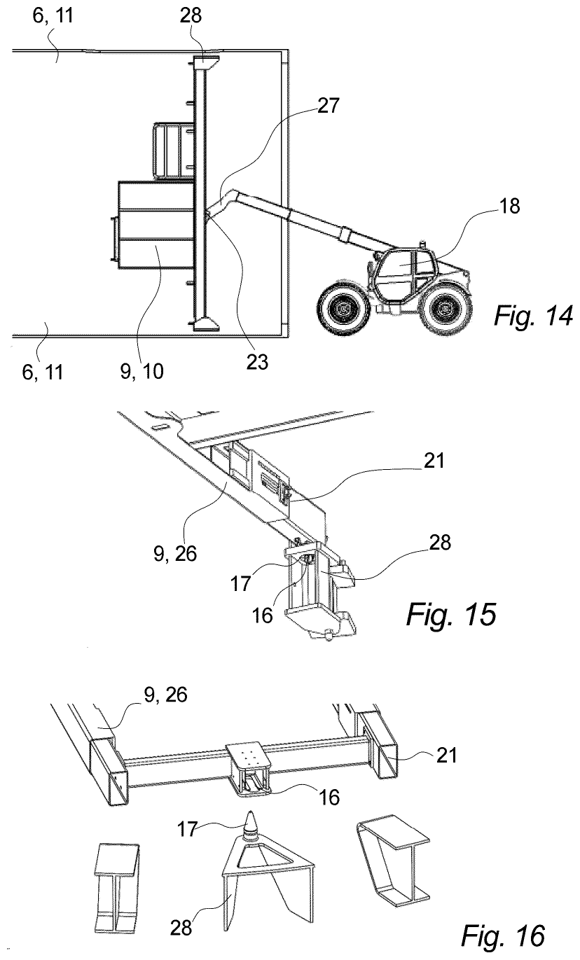

FIG. 12 illustrates a transport vehicle 18 placing a tower platform plate 15 in a tower section 6, as seen in an isometric view, FIG. 13 illustrates a transport vehicle 18 tilting an electrical module 9, as seen in an isometric view, and FIG. 14 illustrates a transport vehicle 18 placing an electrical module 9 in a tower section 6, as seen from the side.

In this embodiment the transport vehicle 18 is a telescopic handler which initially places a first tower platform plate 15 in dedicated brackets connected to the inside surface of the tower section 6. The first tower platform plate 15 is then firmly connected to the dedicated brackets after which the tower section 6 is rotated 180 degrees. A second tower platform plate 15 (not shown in FIGS. 13 and 14 because of the partial cutout of the tower section to enable view of the inside) is then placed in other dedicated brackets by the transport vehicle 18 and firmly connected to the brackets so that a tower platform 13 comprising a gap 14 is formed, wherein the gap 14 is adapted to fit the electrical module 9. The tower section 6 is now rotated 90 degrees and the telescopic handler will connect to the underside of an electrical module 9 by means of vehicle locking means 23—wherein the electrical module 9 is located on a high stand (not shown) to enable access to the underside of the electrical module 9—and transport the electrical module 9 into the tower section 6 while tilting the electrical module 9 substantially 90 degrees by means of a tilting device 27 formed integrally with the telescopic handler. The telescopic handler will then connect the electrical module 9 to the opposing inside surfaces 90 the tower section 6 in the gap 14 in the tower platform 13 formed by the two tower platform plates 15, remotely release the vehicle locking means 23 and move the telescopic handler 18 away e.g., to collect further electrical module.

FIG. 15 illustrates an electrical module 9 comprising manual length adjustment means 21, as seen in an isometric view.

To enable that the length L (see FIG. 19) of the electrical module 9 may be adjusted to fit the specific distance between the opposing inside surfaces 11 inside the tower section 6, the electrical module 9 is in this embodiment provided with length adjustment means 21—in this embodiment in the form of telescopic end parts—which may manually be adjusted in and out to make the electrical module 9 fit the specific part of the often coning tower part 6 where the specific electrical module 9 is to be mounted.

In this embodiment the electrical module 9 is provided with module self-locking means 16 in the form of semi-automatic Twist Locks and the tower section 6 is provided with a connection bracket 28 comprising tower self-locking means 17 in the form of a hole adapted to fit the Twist Lock. I.e., in this embodiment the electrical module 9 will self-lock to the tower section 6 by pushing the Twist Lock against the hole in the bracket 28 to make the spring-biased Twist Lock rotate, pass through the hole and twist back to firmly lock the electrical module 9 to the tower section 6.

FIG. 16 illustrates a first embodiment of module self-locking means 16 and tower self-locking means 17, as seen in an isometric view,

In this embodiment the electrical module 9 is provided with module self-locking means 16 in the form of an opening comprising spring biased flaps adapted to fit tower self-locking means 17 in the form of a peg arranged on a connection bracket 28 in the tower section 6. I.e., in this embodiment the electrical module 9 will self-lock to the tower section 6 by pushing the opening with spring biased flaps against the peg on the bracket 28 to firmly lock the electrical module 9 to the tower section 6. In this embodiment the tower section 6 is provided with additional corner brackets arranged to support the electrical module 9 when the tower section is erected and forms part of a functional wind turbine 1.

FIG. 17 illustrates a second embodiment of module self-locking means 16 and tower self-locking means 17, as seen from the side.

In this embodiment the electrical module 9 is provided with module self-locking means 16 in the form of extending end beams adapted to fit tower self-locking means 17 in the form of connection brackets 28 comprising support openings. I.e., in this embodiment the extending end beams of the electrical module 9 will first be guide upwards into the support openings of the upper connection brackets 28 and then tilted in over the support openings of the bottom connection brackets 28 and lowered until the electrical module 9 rests on the bottom plate in the bottom connection brackets 28 to self-lock the electrical module 9 to the tower section 6. The electrical module 9 is now securely connected to the tower section 6 and it is therefore safe for personnel to enter the tower section 6 and manually place connection means—in the form of bolts, plugs or the like—in corresponding holes in the brackets 28 and the extending end beams of the electrical module 9 to further lock the two together so that the tower section 6 may be rotated and erected without the risk of the initial self-lock connection disengaging.

FIG. 18 illustrates a third embodiment of module self-locking means 16 and tower self-locking means 17, as seen from the side.

The system presented in FIG. 18 is similar to the system presented in FIG. 17 but in this embodiment the electrical module 9 comprises module self-locking means 16 in the form of an upper slit adapted to fit tower self-locking means 17 in the form of a transverse rod on the upper connection brackets 28 so that when the upper slit is brought into engagement with the transverse rod the electrical module 9 is lowered until a lower slit engages a transverse rod on the lower connection brackets 28 and rests on a bottom plate in the bottom connection brackets 28 to self-lock the electrical module 9 to the tower section 6. Hereafter the electrical module 9 is further locked to the tower section 6 by means of connection means.

FIG. 19 illustrates an electrical module 9 comprising automated length adjustment means 21, as seen from one end of the tower section.

In this embodiment the electrical module 9 comprises automated length adjustment means 21 in the form of displaceable end part of the electrical module 9 so that the length L of the electrical module 9 may be adjusted. In this embodiment the length adjustment means 21 comprises electrical actuators arranged to displace the end parts of the electrical module 9 remotely. I.e., in this embodiment the electrical module 9 is brought into the position illustrated in FIG. 19 after which a signal is send to the automated length adjustment means 21 to extend the displaceable end part of the electrical module 9 towards the corresponding connection brackets 28 to make the end part of the electrical module 9 engage the brackets 28 and thereby connect the electrical module 9 to the two opposing inside surfaces 11 of the elongated tubular tower section 6.

The invention has been exemplified above with reference to specific examples of electrical modules 9, tower platforms 13, transport vehicles 18 and other. However, it should be understood that the invention is not limited to the particular examples described above but may be designed and altered in a multitude of varieties within the scope of the invention as specified in the claims.

### LIST

1. Wind turbine
2. Tower
3. Nacelle
4. Rotor
5. Blades
6. Tower section
7. Outer surface of tower section
8. Underlying surface
9. Electrical module
10. Electronic subsystem of wind turbine
11. Opposing inside surfaces of tower section
12. Wind turbine foundation
13. Tower platform
14. Gap
15. Tower platform plates
16. Module self-locking means
17. Tower self-locking means
18. Transport vehicle
19. Further electrical module
20. Further electronic subsystem
21. Length adjustment means
22. Connection means
23. Vehicle locking means
24. First end opening of elongated tubular tower section
25. Second end opening of elongated tubular tower section
26. Base structure
27. Tilting device
28. Connection bracket
29. Scissor arrangement
30. Roller support
31. Carriage arrangement
32. Plate arrangement
33. Height adjustment platform
L. Length of electrical module

1.-17. (canceled)

18. A method for assembling a tower part of a wind turbine, the method comprising:
placing an elongated tubular tower section of the wind turbine so that the elongated tubular tower section is laying down and so that at least a part of an outer elongated surface of the elongated tubular tower section is supported by an underlying surface;
forming an electrical module including at least one electronic subsystem of the wind turbine;
transporting the electrical module into the elongated tubular tower section;
tilting the electrical module substantially 90 degrees; and
connecting the electrical module to at least two opposing inside surfaces of the elongated tubular tower section.

19. The method according to claim 18, wherein the method further comprises erecting the tower section and connecting the tower section to a wind turbine foundation after the electrical module has been connected to the at least two opposing inside surfaces of the elongated tubular tower section.

20. The method according to claim 18, wherein the electrical module forms part of a tower platform inside the tower section once the electrical module is connected to the at least two opposing inside surfaces of the elongated tubular tower section.

21. The method according to claim 18, wherein the method further comprises forming a tower platform inside the elongated tubular tower section before connecting the electrical module to the inside surface of the elongated tubular tower section, wherein the tower platform comprises a gap adapted to fit the electrical module and wherein the electrical module is connected to the at least two opposing inside surface of the elongated tubular tower section in the gap.

22. The method according to claim 18, wherein the method further comprises connecting tower platform plates on opposite sides of the electrical module before transporting the electrical module into the elongated tubular tower section.

23. The method according to claim 18, wherein the method further comprises adjusting a length of the electrical module by means of a length adjuster of the electrical module in accordance with a distance between the at least two opposing inside surfaces of the elongated tubular tower section before connecting the electrical module to the at least two opposing inside surfaces of the elongated tubular tower section.

24. The method according to claim 18, wherein the method further comprises
providing the electrical module with module a self-lock and providing the at least two opposing inside surfaces of the tower section with a tower self-lock before connecting the electrical module to the at least two opposing inside surfaces of the elongated tubular tower section, and
wherein the method further comprises connecting the electrical module to the at least two opposing inside surfaces of the elongated tubular tower section by engaging the module self-lock and the tower self-lock to self-lock the electrical module and the elongated tubular tower section against mutual displacement once the module self-lock and the tower self-lock are engaged.

25. The method according to claim 24, wherein the method further comprises manually connecting the electrical module to the at least two opposing inside surfaces of the elongated tubular tower section by means of connection means after the module self-lock and the tower self-lock are engaged.

26. The method according to claim 18, wherein the electrical module is transported into the elongated tubular tower section and tilted substantially 90 degrees by a same transport vehicle.

27. The method according to claim 18, wherein the electrical module is tilted substantially 90 degrees before the electrical module is transported into the elongated tubular tower section.

28. The method according to claim 18, wherein the method further comprises:
connecting the electrical module to a transport vehicle by means of vehicle locking means before transporting the electrical module into the elongated tubular tower section by means of the transport vehicle, and
remotely disconnecting the electrical module from the transport vehicle by remotely disengaging the vehicle locking means after connecting the electrical module to the at least two opposing inside surfaces of the elongated tubular tower section.

29. The method according to claim 28, wherein the method further comprises moving the transport vehicle out of the elongated tubular tower section after remotely disconnecting the electrical module from the transport vehicle.

30. The method according to claim 18, wherein the method further comprises forming at least one further electrical module comprising at least one further electronic subsystem of the wind turbine,
transporting the at least one further electrical module into the elongated tubular tower section,
tilting the at least one further electrical module substantially 90 degrees, and
connecting the at least one further electrical module to at least two an inside surface of the elongated tubular tower section at a position displaced in relation to the initial electrical module in an elongated direction of the elongated tubular tower section.

31. The method according to claim 30, wherein the electrical module is transported into the elongated tubular tower section through a first end opening of the elongated tubular tower section and wherein the at least one further electrical module is transported into the elongated tubular tower section through a second end opening of the elongated tubular tower section, wherein the first end opening and the second end opening are arranged at opposite ends of the elongated tubular tower section.

32. The method according to claim 18, wherein the method further includes forming the electrical module by placing the at least one electronic subsystem on a base structure of the electrical module and connecting the at least one electronic subsystem to the base structure.

33. The method according to claim 32, wherein the method further comprises tilting the electrical module substantially 90 degrees by tilting the base structure from a substantially horizontal orientation to a substantially vertical orientation.

34. Use of the method according to claim 18, for assembling the tower part of an offshore wind turbine.
